(19) United States
(12) Patent Application Publication
(10) Pub. No.: US 2024/0011722 A1
(43) Pub. Date: Jan. 11, 2024

(54) HEAT EXCHANGER, FIN TUBE MANUFACTURING METHOD, AND HEAT EXCHANGER MANUFACTURING METHOD

(71) Applicant: LG ELECTRONICS INC., Seoul (KR)

(72) Inventors: Hongseong KIM, Seoul (KR); Jaeyoung KIM, Seoul (KR); Seungmo JUNG, Seoul (KR); Hanchoon LEE, Seoul (KR)

(21) Appl. No.: 18/036,530

(22) PCT Filed: Nov. 11, 2021
(86) PCT No.: PCT/KR2021/016466

§ 371 Date: May 11, 2023

(30) Foreign Application Priority Data
Nov. 12, 2020 (KR) 10-2020-0151053

(51) Int. Cl. F28F 3/08; B23P 15/26

(52) U.S. Cl. CPC F28F 3/086; B23P 15/26; F28F 2275/04

(57) ABSTRACT

The present invention relates to a heat exchanger comprising multiple arranged fin tubes, each of which comprises a heat transferring fin and multiple tubes integrally formed on a plate, wherein refrigerant flows through the tubes. Each of the fin tubes has a first surface forming the front surface of the fin tube and a second surface forming the rear surface of the fin tube, and has opening part which communicates with at least a side of the multiple tubes and is formed to extend through the first surface and the second surface; and the perimeters of the openings of the fin tubes adjacent to each other may be connected through a connection part such that the openings of the adjacent fin tubes communicate with each other. Therefore, there is an advantage in that refrigerant can be distributed without a separate header.

### TECHNICAL FIELD

The present disclosure relates to a heat exchanger, a method of manufacturing a fin tube, and a method of manufacturing the heat exchanger. More particularly, the present disclosure relates to a heat exchanger capable of distributing a refrigerant without a separate header, a method of manufacturing a fin tube, and a method of manufacturing the heat exchanger.

### BACKGROUND ART

A heat exchanger can be generally used as a condenser or an evaporator in a refrigeration cycle device including a compressor, a condenser, an expansion device, and an evaporator. Also, a heat exchanger can be installed in an air conditioner, a refrigerator, or the like to exchange heat between a refrigerant and air.

A heat exchanger can be classified into a finned tube type heat exchanger, a microchannel type heat exchanger, and the like.

A heat exchanger may include tubes through which refrigerant for heat exchange with external air passes, a fin coupled between the tubes to improve the heat exchange performance, and a header connected to the tubes to distribute the refrigerant to the tubes.

Meanwhile, in the related art, an insertion hole is formed on one surface of a header through slotting processing or wire cutting and then a tube is inserted into the insertion hole.

For example, Korean Patent Registration No. 10-0644135, which is hereby incorporated by reference, discloses a header having a plurality of insertion holes to which end portions of tubes are coupled.

However, in the related art, each header has to be individually slotted as many times as the number of tubes inserted into the header, which leads to a decrease in the production rate of heat exchangers, thereby reducing the efficiency of mass production.

In addition, in the related art, a separate mold for manufacturing a heat exchanger according to its size is required, leading to a decrease in the production efficiency.

Also, in the related art, a considerable cost is required to manage tolerances that occur during machining of insertion holes.

In addition, in the related art, tolerances generated when processing insertion holes and manufacturing tubes cause an increase in the brazing defect rate.

Further, in the related art, it is difficult to make insertion holes into which tubes are inserted in a constant shape due to abrasion of a blade of the processing equipment, and frequent replacement of a blade is required.

Examples of the related art include Korean Patent Registration No. 10-0644135 (published on Nov. 10, 2006), Korean Utility Model Publication No. 20-2007-0017024 (published on Apr. 27, 2009), Korean Utility Model Registration No. 20-0432601 (published on Dec. 5, 2006), Korean Patent Registration No. 10-1447072 (published on Oct. 6, 2014), and Korean Laid-Open Patent Publication No. 10-2019-0097632 (published on Aug. 21, 2019).

### DISCLOSURE OF INVENTION

### Technical Problem

It is an objective of the present disclosure to solve the above and other problems.

It is another objective of the present disclosure to provide a heat exchanger that does not require a separate header.

It is yet another objective of the present disclosure to provide a heat exchanger that can allow refrigerant to be evenly distributed.

It is yet another objective of the present disclosure to provide a heat exchanger that can increase the efficiency of mass production by improving the production speed and production cost.

It is yet another objective of the present disclosure to provide a heat exchanger that can be flexibly customized according to the size of a product including a heat exchanger without the need for a separate mold.

It is yet another objective of the present disclosure to provide a heat exchanger that does not require an additional slotting process or wire cutting process for the formation of a tube insertion hole.

The objectives of the present disclosure are not limited to the objectives described above, and other objectives not stated herein will be clearly understood by those skilled in the art from the following description.

### Technical Solution

According to an aspect of the subject matter described in this application, a heat exchanger includes a fin tube provided in plurality, each of the plurality of fin tubes including a fin for heat transfer and a plurality of tubes through which refrigerant flows integrally formed on a plate. The fin tube may have a first surface defining a front surface thereof and a second surface defining a rear surface thereof, be provided with an opening in communication with at least one side of the plurality of tubes and formed through the first surface and the second surface, and be configured such that peripheries of openings of fin tubes adjacent to each other may be connected through a connection part, so that the openings of the fin tubes adjacent to each other communicate with each other.

The connection part may protrude in a tube shape from the first surface of the fin tube toward a second surface of a fin tube adjacent to the fin tube.

The connection part may be formed in a tube shape to be joined to the periphery of each of the openings of the fin tubes adjacent to each other.

The connection part may include: a first connection part formed on the periphery of the opening of the first surface; and a second connection part formed on the periphery of the opening of the second surface. The second connection part may be coupled to a first connection part formed on a first surface of a fin tube adjacent to the fin tube.

The first connection part may be configured to protrude from the first surface of the fin tube toward a second surface of a fin tube adjacent to the fin tube, and the second connection part may be configured to protrude from the second surface of the fin tube toward a first surface of a fin tube adjacent to the fin tube.

Accordingly, without the need for a separate mold, a heat exchanger may be manufactured specific to the performance of the heat exchanger by adjusting the number of fin tubes to be coupled, thereby improving the production speed and production cost of the heat exchanger. As a result, the manufacturing efficiency of the heat exchanger may be increased.

A distance between the first surface of the fin tube and a second surface of a fin tube adjacent to the fin tube may be greater than a sum of a thickness of a first tube portion formed on the first surface of the fin tube and a thickness of a second tube portion formed on the second surface of the adjacent fin tube, allowing a space portion to be formed between the tube portions of the fin tubes adjacent to each other.

This may allow air to flow between the plurality of fin tubes, thereby increasing the heat exchange capability of the heat exchanger.

The first connection part may be provided with a protrusion, and a groove into which the protrusion is inserted may be formed in the second connection part coupled to the first connection part.

The protrusion may have a closed-loop shape, and the groove may have a closed-loop shape.

The closed-loop shape may be a ring shape.

Accordingly, assemblability between the fin tubes may be improved to thereby increase the manufacturing efficiency of the heat exchanger.

The plurality of fin tubes may be disposed parallel to each other as first connection parts of the respective plurality of fin tubes and second connection parts of respective adjacent fin tubes are coupled to each other in a continuous manner.

The plurality of fin tubes may be configured such that openings of the respective plurality of fin tubes communicate with each other to define a refrigerant passage that supplies refrigerant to the plurality of tubes formed on the respective plurality of fin tubes or receives refrigerant from the plurality of tubes formed on the respective plurality of fin tubes.

As a separate header is not required, an additional slotting process or wire cutting process for the formation of a tube insertion hole in a header may not be needed, thereby improving the production speed and production cost of the heat exchanger. As a result, the manufacturing efficiency of the heat exchanger may be increased.

Each of the plurality of fin tubes may have the opening on each of one side and another side of the plurality of tubes.

Each of the plurality of fin tubes may have the opening on each of one side and another side of the plurality of tubes, and between the one side and the another side of the plurality of tubes.

Accordingly, although refrigerant is unevenly distributed in the heat exchanger, the refrigerant may be redistributed in the middle of a refrigerant flow path, allowing the refrigerant to be uniformly distributed.

Each of the plurality of fin tubes may be formed of a single plate. Each of the plurality of fin tubes may be formed of a first plate and a second plate that are joined to each other. The first surface may be an outer surface of the first plate, and the second surface may be an outer surface of the second plate.

The first plate and the second plate may be joined to each other to define the fin except portions where the plurality of tubes and the opening are formed.

The opening may be spaced a predetermined distance apart from each of edges of the first plate and the second plate toward the plurality of tubes. The fin may include a fin portion formed between the opening and the edge of the first plate, and the opening and the edge of the second plate.

Accordingly, the performance of the heat exchanger may be improved by increasing the area of heat exchange with air flowing between the fin tubes.

According to another aspect of the subject matter described in this application, a method of manufacturing a fin tube is provided. The method may include: cutting a first plate and a second plate into a size of the fin tube; coupling the first plate and the second plate to each other to respectively form tube portions defining a tube in a protruding manner and forming an opening on at least one side of each of the tube portions to be spaced apart from each of edges of the first plate and the second plate; forming a first connection part on a periphery of the opening of the first plate and forming a second connection part on a periphery of the opening of the second plate; and joining an inner surface of the first plate and an inner surface of the second plate together.

According to another aspect of the subject matter described in this application, a method of manufacturing a heat exchanger is provided. The method may include, after manufacturing the fin tube in a plurality number according to the method of claim 18, coupling a first connection part of the fin tube and a second connection part of a fin tube adjacent to the fin tube to each other.

A distance between a first plate of the fin tube and a second plate of the adjacent fin tube may be greater than a sum of a thickness of a first tube portion formed on the first plate of the fin tube and a thickness of a second tube portion formed on the second plate of the adjacent fin tube, so as to form a space portion between the fin tubes adjacent to each other.

A protrusion may be formed on the first connection part of the fin tube, and a groove may be formed in the second connection part of the adjacent fin tube, so as to allow the protrusion to be inserted into the groove.

A filler metal may be added to at least one of the protrusion and the groove to braze the first connection part and the second connection part together.

The fin tube may include a fin portion formed between the opening and an edge of a plate.

Details of other embodiments are included in the detailed description and the accompanying drawings.

### Advantageous Effects

A heat exchanger according to the present disclosure has one or more of the following effects.

First, as fin tubes each having a first connection part and a second connection part are coupled to each other in a continuous or sequential manner to define a refrigerant flow path serving as a header through which refrigerant flows, a separate header may not be required.

Second, as a plurality of first connection parts and a plurality of second connection parts are provided on each fin tube in a longitudinal direction of the fin tube to define a plurality of refrigerant flow paths, even when refrigerant is unevenly distributed in the heat exchanger, the refrigerant may be redistributed in an intermediate refrigerant flow path to thereby allow the refrigerant to be uniformly distributed.

Third, as first connection parts and second connection parts formed on each fin tube are coupled to each other in a continuous manner, like Legos, assemblability may be improved. Accordingly, the production speed and production cost may be improved to thereby increase the production efficiency.

Fourth, as a separate mold is not required, a heat exchanger may be flexibly customized according to the size of a product including the heat exchanger.

Fifth, as a separate header is not required, the process of forming an insertion hole for inserting a tube into a header may be omitted, thereby reducing the manufacturing cost of the heat exchanger.

The effects of the present disclosure are not limited to the effects described above, and other effects not mentioned will be clearly understood by those skilled in the art from the claims.

### BRIEF DESCRIPTION OF DRAWINGS

FIG. 1 is a perspective view of a heat exchanger according to one embodiment of the present disclosure.

FIG. 2 is an exploded perspective view of a heat exchanger according to one embodiment of the present disclosure, seen from one side.

FIG. 3 is an exploded perspective view of a heat exchanger according to one embodiment of the present disclosure, seen from another side.

FIG. 4 is a perspective view of a fin tube according to one embodiment of the present disclosure, viewed from one side.

FIG. 5 is a perspective view of a fin tube according to one embodiment of the present disclosure, viewed from another side.

FIG. 6 is a cross-sectional perspective view illustrating an example of I-I′ shown in FIG. 4.

FIG. 7 is a cross-sectional perspective view illustrating another example of I-I′ shown in FIG. 4.

FIG. 8 is a cross-sectional perspective view illustrating yet another example of I-I′ shown in FIG. 4.

FIG. 9 is a longitudinal cross-sectional view of a heat exchanger according to one embodiment of the present disclosure.

FIG. 10 is a longitudinal cross-sectional view of a heat exchanger according to another embodiment of the present disclosure.

FIG. 11 is an exploded perspective view of a heat exchanger according to yet another embodiment of the present disclosure.

FIG. 12 is a block diagram illustrating a method of manufacturing a fin tube and a method of manufacturing a heat exchanger according to one embodiment of the present disclosure.

### MODE FOR INVENTION

The above and other aspects, features and other advantages of the present disclosure will be more clearly understood from the following detailed description taken in conjunction with the accompanying drawings. Exemplary embodiments will now be described more fully hereinafter with reference to the accompanying drawings; however, they may be embodied in many different forms and should not be construed as limited to the embodiments set forth herein. Rather, these embodiments are provided so that this disclosure will be thorough and complete, and will fully convey the scope of the exemplary embodiments to those skilled in the art. The same reference numerals are used throughout the drawings to designate the same or similar components.

Spatially relative terms, such as, “below”, “beneath”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated at other orientations) and the spatially relative terms used herein interpreted accordingly.

The terminology used herein is for the purpose of describing particular embodiments only and is not intended to limit the full scope of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, steps, and/or operations, but do not preclude the presence or addition of one or more other components, steps, and/or operations.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

In the drawings, the thickness or size of each component is exaggerated, omitted, or schematically shown for the sake of convenience and clarity. Also, the size and area of each component do not entirely reflect the actual size or area thereof.

Hereinafter, a heat exchanger according to embodiments of the present disclosure will be described with reference to the accompanying drawings.

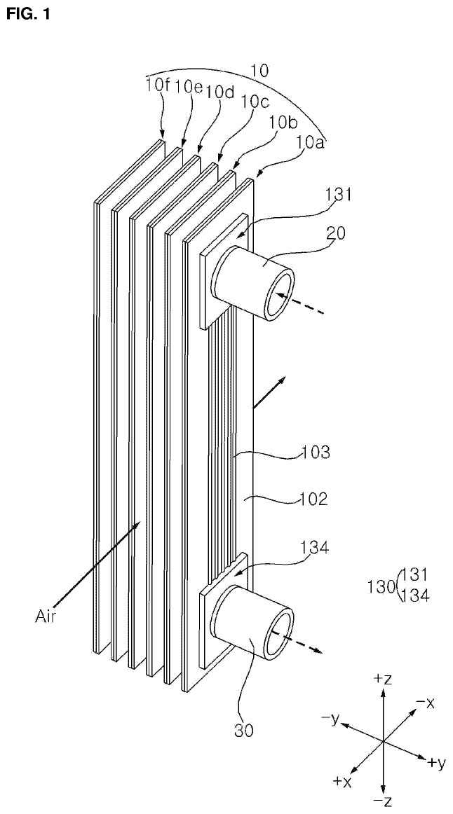

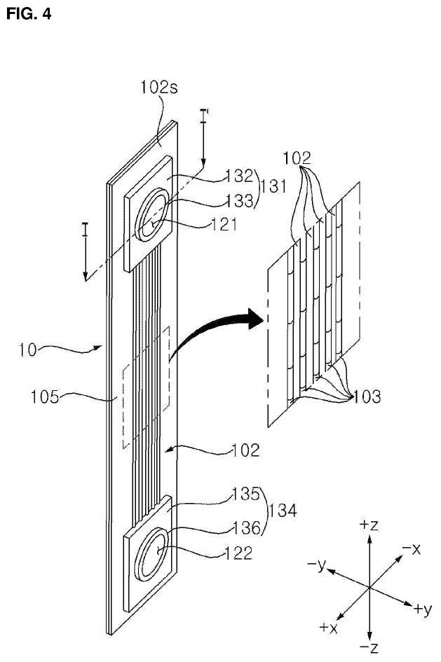

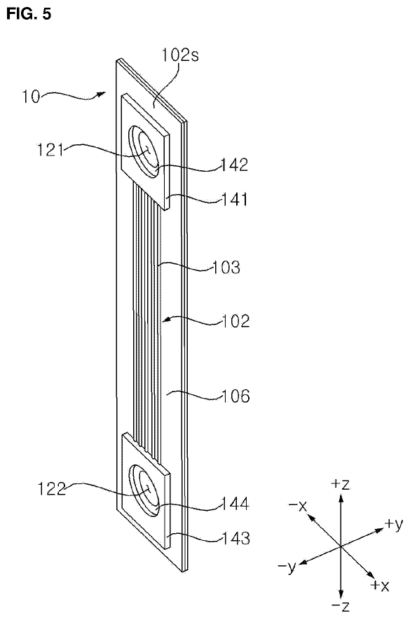

In the following description, with respect to FIGS. 1 to 11, all areas (or joints) where insertion, coupling, fitting, contact, joining, or assembly is made between two or more components of the heat exchanger may be formed by brazing. A filler metal may be added to all areas where insertion, coupling, fitting, contact, joining, or assembly is made between two or more components of the heat exchanger. The heat exchanger may be put into a furnace with a filter metal being added thereto and then be exposed to a high-temperature condition for a certain period of time to be brazed. The description related to the brazing will be omitted below.

Hereinafter, the directions of the heat exchanger and its components according to embodiments of the present disclosure will be defined based on the coordinate system shown in FIGS. 1 to 11.

The x-axis direction may be defined as the left-and-right direction. Based on the origin, the +x axis direction may be the left direction, and the −x axis direction may be the right direction. The y-axis direction may be defined as the front-and-rear direction. Based on the origin, the +y axis direction may be the front direction, and the −y axis direction may be the rear direction. The z-axis direction may be defined as the up-and-down direction. Based on the origin, the +z axis direction may be the up direction, and the −z axis direction may be the down direction.

Referring to FIG. 1, the heat exchanger according to one embodiment of the present disclosure may include a fin tube 10 of a plurality number, a first pipe 20, and a second pipe 30.

The fin tube 10 may extend in the up-and-down direction. The fin tube 10 may be configured such that a plurality of tubes 103 through which refrigerant flows and a fin 102 for heat transfer are integrally formed on a plate.

The fin tube 10 may be provided in plurality, and the plurality of fin tubes 10 may be arranged in parallel and adjacent to each other in the front-and-rear direction. A fin tube 10, among the plurality of fin tubes 10, and an adjacent fin tube 10 thereof, namely, fin tubes 10 adjacent to each other may be connected to each other.

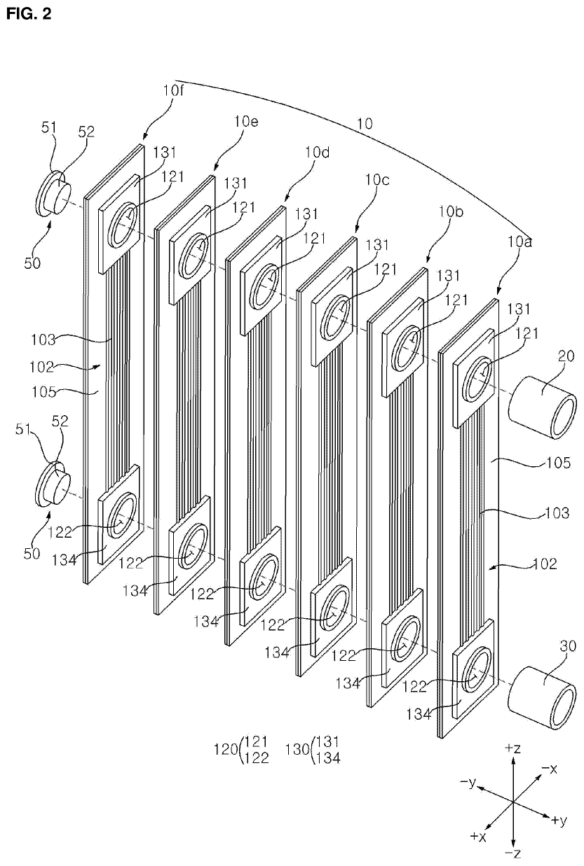

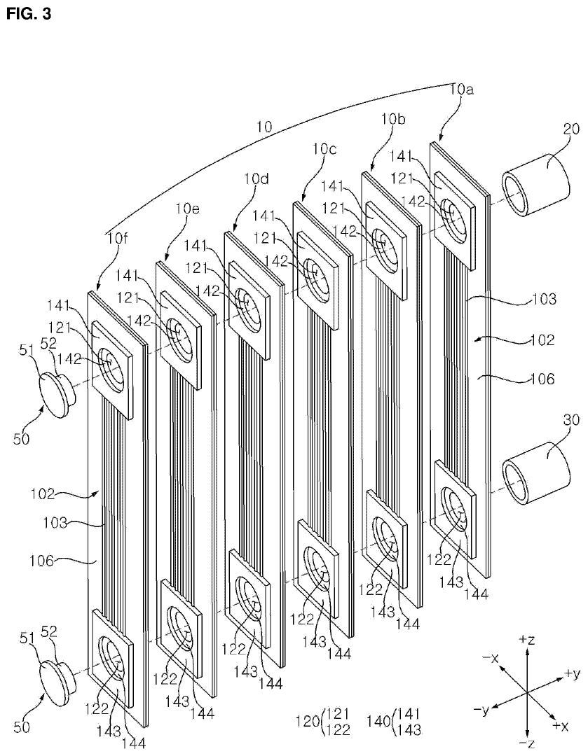

The fin tube 10 may include a connection part on each of front and rear surfaces thereof. The connection part may include a first connection part 130 formed on the front surface and a second connection part 140 formed on the rear surface. The first connection part 130 may include a first upper connection part 131 and a first lower connection part 134 (see FIGS. 2 and 3).

The first upper connection part 131 may be disposed on one part (or portion) of the front surface of the fin tube 10. The first lower connection part 134 may be disposed on another (or opposite) part of the front surface of the fin tube 10.

The first upper connection part 131 may be in communication with one end of the plurality of tubes 103. The first lower connection part 134 may be in communication with another (or opposite) end of the plurality of tubes 103.

The first pipe 20 may correspond to a refrigerant inlet pipe through which refrigerant is introduced. The first pipe 20 may be in communication with a first upper connection part 131 formed on a fin tube 10a located in the foremost position. Accordingly, the refrigerant may be introduced into the fin tube 10 through the first pipe 20.

The second pipe 30 may correspond to a refrigerant outlet pipe through which refrigerant is discharged. The second pipe 30 may be in communication with a first lower connection part 134 formed on the fin tube 10a located in the foremost position. Accordingly, the refrigerant may be discharged to an outside of the fin tube 10 through the second pipe 30.

When refrigerant is flowing in the plurality of fin tubes 10, air may exchange heat with the refrigerant while passing between the plurality of fin tubes 10.

Referring to FIGS. 2 to 5, the heat exchanger according to one embodiment of the present disclosure may include the fin tube 10 provided in plurality and a stopper block 50.

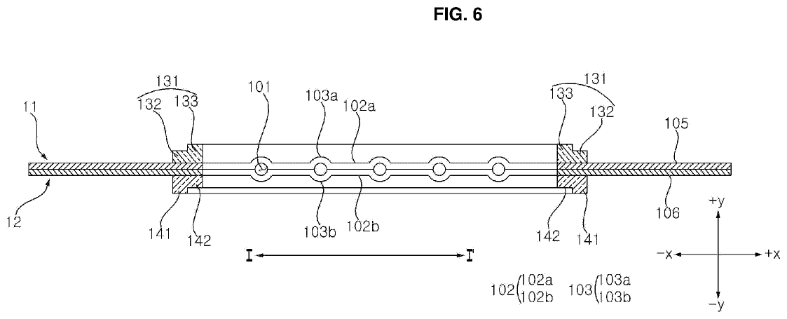

The fin tube 10 may be formed of a single plate. The fin tube 10 may be formed of a first plate 11 and a second plate 12 that are joined to each other (see FIG. 6).

The fin tube 10 may include a first surface 105 and a second surface 106 that define an outer surface thereof. The first surface 105 may define the front surface of the fin tube 10, and may define an outer surface of the first plate 11. The second surface 106 may define the rear surface of the fin tube 10, and may define an outer surface of the second plate 11.

The fin tube 10 may be provided with an opening 120 in communication with at least one side of the plurality of tubes 103 and formed through the first surface 105 and the second surface 106 of the fin tube 10.

The opening 120 may be formed on each of one side and another side of the plurality of tubes 103. The opening 120 may be spaced a predetermined distance apart from an edge of the plate toward the plurality of tubes 103. The opening 120 may be formed in a circular shape, which is preferable, but the present disclosure is not limited thereto.

The opening 120 may include a first opening 121 and a second opening 122.

The first opening 121 may be formed in one part of the fin tube 10. The first opening 121 may be spaced a predetermined distance apart from an upper edge of the fin tube 10 toward the plurality of tubes 103. The first opening 121 may be in communication with one end of the plurality of tubes 103.

The second opening 122 may be formed in another part of the fin tube 10. The second opening 122 may be spaced a predetermined distance apart from a lower edge of the fin tube 10 toward the plurality of tubes 103. The second opening 122 may be in communication with another end of the plurality of tubes 103.

The first opening 121 and the second opening 122 may be spaced apart from each other by a predetermined distance along a longitudinal direction of the fin tube 10. The first opening 121 and the second opening 122 may have the same shape and structure.

The fin tube 10 may be configured such that the first plate 11 and the second plate 12 are joined to each other to define the fin 102. The fin 102 may correspond to a remaining portion, which is the rest of the fin tube 10 except portions where the plurality of tubes 103 and the opening 120 are formed.

The fin 102 may include a fin portion 102s formed between the opening 120 and the edge of the plate.

In the case of a finned tube type heat exchanger of the related art, as a plurality of tubes are inserted into a header, the remaining portion except the plurality of tubes only corresponds to the area of a fin. However, in the case of the fin 102 according to one embodiment of the present disclosure, as the process of inserting the fin tube 10 into a header is omitted, the fin portion 102s may be further provided to thereby increase the total area of the fin 102. As a result, the efficiency of heat exchange between the heat exchanger and air may be increased.

The fin tube 10 may be configured such that openings 120 of fin tubes 10 adjacent to each other are connected through connection parts provided around the openings 120, so that the openings 120 of the fin tubes 10 adjacent to each other communicate with each other.

The connection part may be formed in a tube shape protruding from a first surface 105 of a fin tube 10, among the plurality of fin tubes 10, toward a second surface 106 of a fin tube 10 adjacent to the fin tube 10, namely, an adjacent fin tube 10. The connection part may be formed in a tube shape to be joined to a periphery of each of openings 120 of fin tubes 10 adjacent to each other.

The connection part may include the first connection part 130 formed on the periphery of the opening 120 of the first surface 105 of the fin tube and the second connection part 140 formed on the periphery of the opening 120 of the second surface 106 of the fin tube 10.

The first connection part 130 may be configured to protrude from a first surface 105 of a fin tube 10, among the plurality of fin tubes 10, toward a second surface 106 of an adjacent fin tube 10. A protrusion 133, 136 may be formed on the first connection part 130. The protrusion 133, 136 may have a closed-loop shape or a ring shape, but the present disclosure is not limited thereto.

The second connection part 140 may be configured to protrude from a second surface 106 of a fin tube 10, among the plurality of fin tubes 10, toward a first surface 105 of an adjacent fin tube 10. A groove 142, 144 into which the protrusion 133, 136 of the first connection part 130 is inserted may be formed in the second connection part 140. The groove 142, 144 may have a closed-loop shape or a ring shape, but the present disclosure is not limited thereto.

As the protrusion 133, 136 of the first connection part 130 is inserted into the groove 142, 144 of the second connection part 140, the second connection part 140 may be coupled to the first connection part 130 formed on the first surface 105 of the adjacent fin tube 10.

As first connection parts 130 formed on the respective plurality of fin tubes 10 and second connection parts 140 formed on respective adjacent fin tubes 10 are coupled to each other in a continuous or sequential manner, the plurality of fin tubes 10 may be arranged in parallel to each other.

The first connection part 130 may be formed on the first surface 105 of the fin tube 10. The first connection part 130 may be formed around the opening 120. The first connection part may include a connection part body 132, 135 and the protrusion 133, 136.

The connection part body 132, 135 may protrude forward from the first surface 105 of the fin tube 10 by a predetermined distance. The protrusion 133, 136 may protrude forward from the connection part body 132, 135 by a predetermined distance.

The connection part body 132, 135 and the protrusion 133, 136 may form a step (or stepped portion) therebetween.

The first connection part 130 may include the first upper connection part 131 and the first lower connection part 134.

The first upper connection part 131 may be formed on one part of the fin tube 10. The first upper connection part 131 may include an upper body 132 and an upper protrusion 133.

The upper body 132 may be formed on the one part of the fin tube 10. The upper body 132 may protrude from the first surface 105 of the fin tube 10 by a predetermined distance. The upper protrusion 133 may be formed on one surface of the upper body 132. The upper body 132 and the upper protrusion 133 may form a step therebetween.

The upper protrusion 133 may protrude from the upper body 132 by a predetermined distance. The upper protrusion 133 may protrude forward by a predetermined distance. The upper protrusion 133 may have a closed-loop shape. The closed-loop shape may be a ring shape, but the present disclosure is not limited thereto. An inner diameter of the upper protrusion 133 may correspond to a diameter of the first opening 121.

The first lower connection part 131 may be formed on another part of the fin tube 10. The first lower connection part 134 may include a lower body 135 and a lower protrusion 136.

The lower body 135 may be formed on the another part of the fin tube 10. The lower body 135 may protrude from the first surface 105 of the fin tube 10 by a predetermined distance. The lower protrusion 136 may be formed on one surface of the lower body 135. The lower body 135 and the lower protrusion 136 may form a step therebetween.

The lower protrusion 136 may protrude from the lower body 135 by a predetermined distance. The lower protrusion 136 may protrude forward by a predetermined distance. The lower protrusion 136 may have a closed-loop shape. The closed-loop shape may be a ring shape, but the present disclosure is not limited thereto. An inner diameter of the lower protrusion 136 may correspond to a diameter of the second opening 122.

The second connection part 140 may be formed on the second surface 106. The second connection part 140 may be formed around the opening 120. The second connection part 140 may be provided with a groove 142, 144 into which a protrusion 133, 136 of an adjacent fin tube 10 is inserted.

The groove 142, 144 may be recessed into the second connection part 140. The groove 142, 144 may have a closed-loop shape. The closed-loop shape may be a ring shape, but the present disclosure is not limited thereto. The shape of the groove 142, 144 may correspond to the shape of the protrusion 133, 136.

An outer diameter of the groove 142, 144 may correspond to an outer diameter of the protrusion 133, 136. An inner diameter of the groove 142, 144 may correspond to an inner diameter of the protrusion 133, 136. A peripheral (or circumferential) surface of the groove 142, 144 may be in contact with a peripheral (or circumferential) surface of the protrusion 133, 136.

The second connection part 140 may include a second upper connection part 141 and a second lower connection part 143.

The second upper connection part 141 may be formed on one part of the fin tube 10. The second upper connection part 141 may have an upper groove 142 into which an upper protrusion 133 of an adjacent fin tube 10 is inserted.

The upper groove 142 may be formed in a central portion of the second upper connection part 141. The upper groove 142 may be recessed into the second upper connection part 141.

The upper groove 142 may have a closed-loop shape. The closed-loop shape may correspond to various shapes such as a ring shape. The shape of the upper groove 142 may correspond to the shape of the upper protrusion 133.

An outer diameter of the upper groove 142 may correspond to an outer diameter of the upper protrusion 133. An inner diameter of the upper groove 142 may correspond to an inner diameter of the upper protrusion 133. A peripheral surface of the upper groove 142 may be in contact with a peripheral surface of the upper protrusion 133.

The second lower connection part 143 may be formed on another part of the fin tube 10. The second lower connection part 143 may have a lower groove 144 into which a lower protrusion 136 of an adjacent fin tube 10 is inserted.

The lower groove 144 may be formed in a central portion of the second lower connection part 143. The lower groove 144 may be recessed into the second lower connection part 143. The upper groove 142 may extend toward the second surface 106 of the fin tube 10.

The lower groove 144 may have a closed-loop shape. The closed-loop shape may correspond to various shapes such as a ring shape. The shape of the lower groove 144 may correspond to the shape of the lower protrusion 136.

An outer diameter of the lower groove 144 may correspond to an outer diameter of the lower protrusion 136. An inner diameter of the lower groove 144 may correspond to an inner diameter of the lower protrusion 136. A peripheral surface of the lower groove 144 may be in contact with a peripheral surface of the lower protrusion 136.

The stopper block 50 may be inserted into a second connection part 140 of a fin tube 10f located in the rearmost position among the plurality of fin tubes 10, and may include a stopper body 51 and a stopper protrusion 52. Therefore, the leakage of refrigerant flowing in the plurality of fin tubes 10 may be prevented.

The stopper body 51 may have a disk shape, but the present disclosure is not limited thereto. The stopper body 51 may have a shape corresponding to the groove 142, 144 of the second connection part 140. The stopper body 51 may be inserted into the second connection part 140, and the stopper body 51 and the groove 142, 144 of the second connection part 140 may come in contact with each other.

The stopper protrusion 52 may have a cylindrical shape, but the present disclosure is not limited thereto. The stopper protrusion 52 may have a shape corresponding to an inside of the second connection part 140 except the groove 142, 144 of the second connection part 140. The stopper protrusion 52 and the inside of the second connection part 140 excluding the groove 142, 144 may come in contact with each other.

Referring to FIG. 6, an inner surface of the first plate 11 and an inner surface of the second plate 12 may be joined to each other to define the fin tube 10. The first plate 11 and the second plate 12 may have the same shape except the first connection part 130 and the second connection part 140.

The outer surface of the first plate 11 may correspond to the first surface 105, and the outer surface of the second plate 12 may correspond to the second surface 106.

The first plate 11 and the second plate 12 may be joined to each other to define the plurality of tubes 103 and the fin 102. A tube hole 101 through which refrigerant flows may be formed in the plurality of tubes 103.

The first plate 11 may include a first flat portion 102a formed at a position corresponding to the fin 102 and a first tube portion 103a formed at a position corresponding to the plurality of tubes 103. The first flat portion 102a and the first tube portion 103a may extend in a longitudinal direction of the first plate 11, and may each be provided in plurality so as to be alternately arranged in the left-and-right direction.

The first tube portion 103a may protrude from the first surface 105 of the first plate 11 by a predetermined distance. A cross section of the first tube portion 103a may come in various shapes such as a semicircular shape.

The second plate 12 may include a second flat portion 102b formed at a position corresponding to the fin 102 and a second tube portion 103b formed at a position corresponding to the plurality of tubes 103. The second flat portion 102b and the second tube portion 103b may extend in a longitudinal direction of the second plate 12, and may each be provided in plurality so as to be alternately arranged in the front-and-rear direction.

The second tube portion 103b may protrude from the second surface 106 of the second plate 12 by a predetermined distance. A cross section of the second tube portion 103b may come in various shapes such as a semicircular shape.

The first flat portion 102a and the second flat portion 102b may be coupled to face each other to thereby define the fin 102. The first tube portion 103a and the second tube portion 103b may be coupled to face each other to thereby define the tube hole 101 and the tube 103.

The first upper connection part 131 may be formed on the first surface 105 of the first plate 11. The first upper connection part 131 may protrude from the first surface 105. An overall cross-sectional shape of the first upper connection part 131 may be a reversed “T” shape with a stepped portion. The first upper connection part 131 may include the upper body 132 protruding from the first surface 105 and the upper protrusion 133 protruding from the upper body 132.

The second upper connection part 141 may be formed on the second surface 106 of the second plate 12. The second upper connection part 141 may protrude from the second surface 106. An overall cross-sectional shape of the second upper connection part 141 may correspond to an “n” shape. The second upper connection part 141 may have the upper groove 142 recessed inwardly.

The upper protrusion 133 of the first upper connection part 131 may be inserted into an upper groove 142 of a second upper connection part 141 of an adjacent fin tube 10. The upper groove 142 may have a shape corresponding to the upper protrusion 133. Accordingly, the first upper connection part 131 of the fin tube 10 and the second upper connection part 141 of the adjacent fin tube 10 may be coupled to each other.

Likewise, as described above, the lower protrusion 136 of the first lower connection part 134 may be inserted into the lower groove 144 of the second lower connection part 143. Accordingly, the first lower connection part 134 of the fin tube 10 and a second lower connection part 143 of an adjacent fin tube may be coupled to each other.

The first connection part 130 and the second connection part 140 may be formed in various shapes, and the protrusion 133, 136 of the first connection part 130 and the groove 142, 144 of the second connection part 140 may also be formed in various shapes.

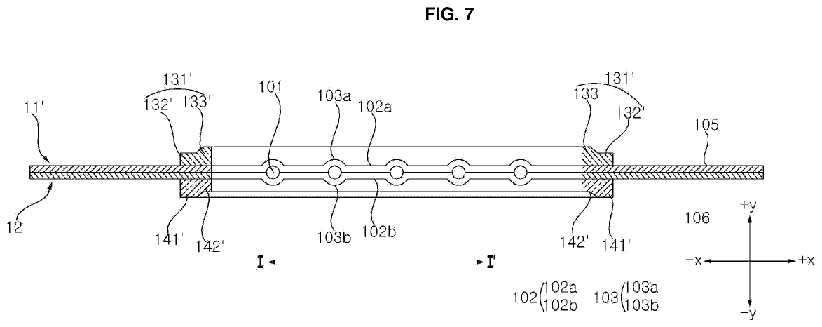

For example, referring to FIG. 7, an upper protrusion 133′ of a first upper connection part 131′ may have an outer diameter that gradually decreases as a distance from an upper body 123′ increases. The upper protrusion 133′ may be formed in a truncated cone shape having a hollow in its center, and may include an inclined surface.

An upper groove 142′ of a second upper connection part 141′ may have a shape corresponding to the upper protrusion 133′, so as to allow the upper protrusion 133′ to be inserted into the upper groove 142′.

The description of the first upper connection part 131′ may be equally applied to a first lower connection part. That is, the description of the upper protrusion 133′ may be equally applied to a lower protrusion, and the description of the upper groove 142′ may be equally applied to a lower groove.

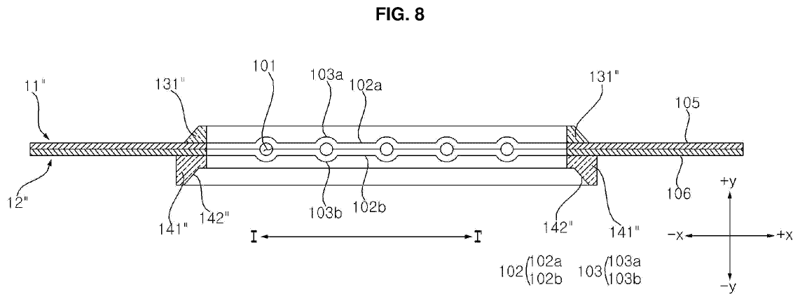

In another example, referring to FIG. 8, a first upper connection part 131″ may have an outer diameter that gradually decreases as a distance from the first surface 105 increases. The first upper connection part 131″ may be formed in a truncated cone shape having a hollow in its center, and may include an inclined surface. The first upper connection part 131″ may serve the same role as a protrusion. Therefore, the first upper connection part 131″ may be referred to as a protrusion.

An upper groove 142″ of a second upper connection part 141″ may have a shape corresponding to the shape of the first upper connection part 131″. The first upper connection part 131″ may be inserted into the upper groove 142″.

The description of the first upper connection part 131″ may be equally applied to a first lower connection part.

As a contact area between the groove (142′, 142″) and the protrusion (131′, 131″) increases, the quality of brazing may be improved, and as the groove (142′, 142″) and the protrusion (131′, 131″) are coupled to each other along the inclined surface, assembly between the fin tubes 10 may be improved.

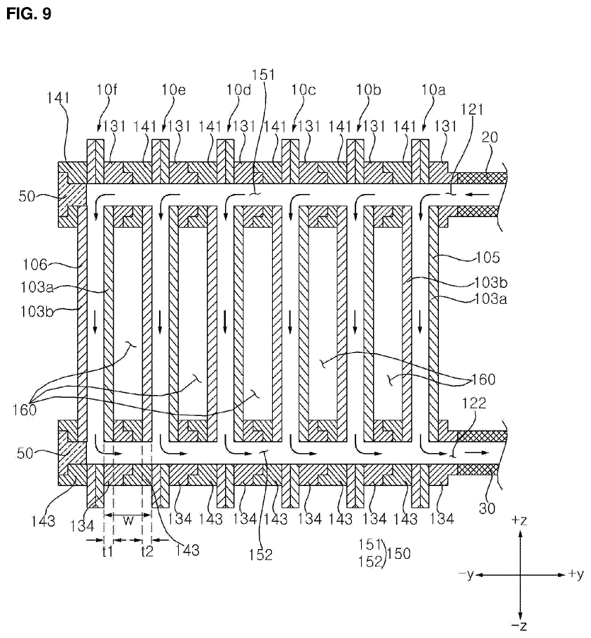

Referring to FIG. 9, the plurality of fin tubes 10 may be configured such that respective openings 120 thereof communicate with each other. The respective openings 120 may be in communication with each other to define a refrigerant passage 150. The first connection parts 130 of the plurality of fin tubes and the second connection parts 140 of respective adjacent fin tubes 10 may be coupled to each other to define the refrigerant passage 150.

The refrigerant passage 150 may supply refrigerant to the plurality of tubes 103 or receive refrigerant from the plurality of tubes 103. The refrigerant passage 150 may include a first refrigerant passage 151 and a second refrigerant passage 152.

The first refrigerant passage 151 may be formed on one side of the plurality of fin tubes 10. First openings 121 formed on one side of the respective plurality fin tubes 10 may be in communication with each other to define the first refrigerant passage 151. The first refrigerant passage 151 may be in communication with the first pipe 20. Accordingly, refrigerant may be introduced into the first refrigerant passage 151 from the first pipe 20. The first refrigerant passage 151 may be in communication with one end of the plurality of tubes 103. Thus, the refrigerant may be distributed to the plurality of tubes 103 along the first refrigerant passage 151.

The second refrigerant passage 152 may be formed on another side of the plurality of fin tubes 10. Second openings 122 formed on another (or opposite) side of the respective plurality of fin tubes 10 may be in communication with each other to define the second refrigerant passage 152. The second refrigerant passage 152 may be in communication with another end of the plurality of tubes 103. Accordingly, refrigerant may be introduced into the second refrigerant passage 152 from the plurality of tubes 103. The second refrigerant passage 152 may be in communication with the second pipe 30. Thus, the refrigerant may be discharged to the second pipe 30 from the second refrigerant passage 152.

As the refrigerant passage 150 serves the same role as a header that supplies/branches refrigerant, a separate header may not be required. Thus, unlike a finned tube type heat exchanger of the related art, the process of inserting a fin tube into a header is not required to thereby increase the productivity of the heat exchanger.

As a fin tube 10, among the plurality of fin tubes 10, and an adjacent fin tube 10 are coupled to each other, namely, fine tubes 10 adjacent to each other are coupled to each other, a space portion 160 through which air flows may be formed between the fin tubes 10 adjacent to each other. The space portion 160 may be formed between tube portions (113, 123) of fin tubes 10 adjacent to each other. The space portion 160 may be formed between a first tube portion 103a of a fin tube 10, among the plurality of fin tubes 10, and a second tube portion 103b of an adjacent fin tube 10.

The space portion 160 may be formed when a distance w between a first surface 105 of a fin tube 10, among the plurality of fin tubes 10, and a second surface 106 of an adjacent fin tube 10 is greater than the sum of a thickness t1 of a first tube portion 103a formed on the first surface 105 of the fin tube 10 and a thickness t2 of a second tube portion 103b formed on the second surface 106 of the adjacent fin tube 10.

As the space portion 160 is provided, air may exchange heat with the plurality of fin tubes 10 while flowing in the left-and-right direction along the space portion 160.

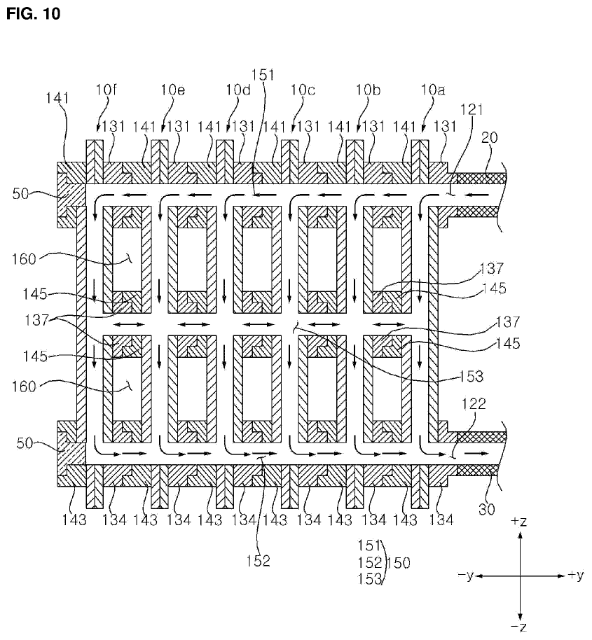

Hereinafter, the heat exchanger according to another embodiment of the present disclosure will be described with reference to FIG. 10. An opening 120 may be formed on each of one side and another (or opposite) side of the plurality of tubes 103 of the fin tube 10, and between the one side and the another side of the plurality of tubes 103.

The opening 120 may include a first opening 121 formed on one side of the plurality of tubes 103, a second opening 122 formed on another side of the plurality of tubes 103, and a third opening formed between the one side and the another side of the plurality of tubes 103. The third opening may be formed between the first opening 121 and the second opening 122, and may be provided in plurality.

A first connection part 130 may be formed around an opening 120 of the first surface 105, and may include a first upper connection part 131, a first lower connection part 134, and a first middle connection part 137. The first upper connection part 131 may be formed on a periphery of the first opening 121, the first lower connection part 134 may be formed on a periphery of the second opening 122, and the first middle connection part 137 may be formed on a periphery of the third opening.

The first middle connection part 137 may have the same shape and structure as the first upper connection part 131 and the first lower connection part 134. Accordingly, the descriptions of the first upper connection part 131 and the first lower connection part 134 may be equally applied to the first middle connection part 137.

The second connection part 140 may be formed around an opening 120 of the second surface 106, and may include a second upper connection part 141, a second lower connection part 143, and a second middle connection part 145. The second upper connection part 141 may be formed on a periphery of the first opening 121, the second lower connection part 143 may be formed on a periphery of the second opening 122, and the second middle connection part 145 may be formed on a periphery of the third opening.

The second middle connection part 145 may have the same shape and structure as the second upper connection part 141 and the second lower connection part 143. Therefore, the descriptions of the second upper connection part 141 and the second lower connection part 143 may be equally applied to the second middle connection part 145.

Among the plurality of fin tubes 10, a first surface 105 of a fin tube 10a located in the foremost position and a second surface 106 of a fin tube located in the rearmost position may not include the third opening to prevent refrigerant leakage. Accordingly, the fin tube 10a located in the foremost position may not include the first middle connection part 137, and the fin tube 10f located in the rearmost position may not include the second middle connection part 145.

The plurality of fin tubes 10 may be formed such that respective openings 120 thereof communicate with each other. The respective openings 120 may be in communication with each other to define a refrigerant passage 150.

The refrigerant passage 150 may include a first refrigerant passage 151, a second refrigerant passage 152, and a third refrigerant passage 153. The third refrigerant passage 153 may be formed between the first refrigerant passage 151 and the second refrigerant passage 152, and may be provided in plurality. Third openings formed in respective plurality of fin tubes 10 may be in communication with each other to define the third refrigerant passage 153. The third refrigerant passage 153 may be supplied with refrigerant from the first refrigerant passage 151 and then supply the refrigerant to the second refrigerant passage 152.

Referring to the flow of refrigerant in the heat exchanger, refrigerant may flow into the first refrigerant passage 151 through the first pipe 20. The refrigerant introduced into the first refrigerant passage 151 may be distributed to the third refrigerant passage 153 along the plurality of tubes 103. The refrigerant introduced into the third refrigerant passage 153 may be uniformly distributed in the third refrigerant passage 153 and then be distributed to the second refrigerant passage 152 along the plurality of tubes 103. The refrigerant distributed into the second refrigerant passage 152 may be discharged to an outside of the heat exchanger through the second pipe 30.

Thus, even when refrigerant is unevenly distributed in the heat exchanger, the refrigerant may be redistributed evenly in the heat exchanger through the third refrigerant passage 153.

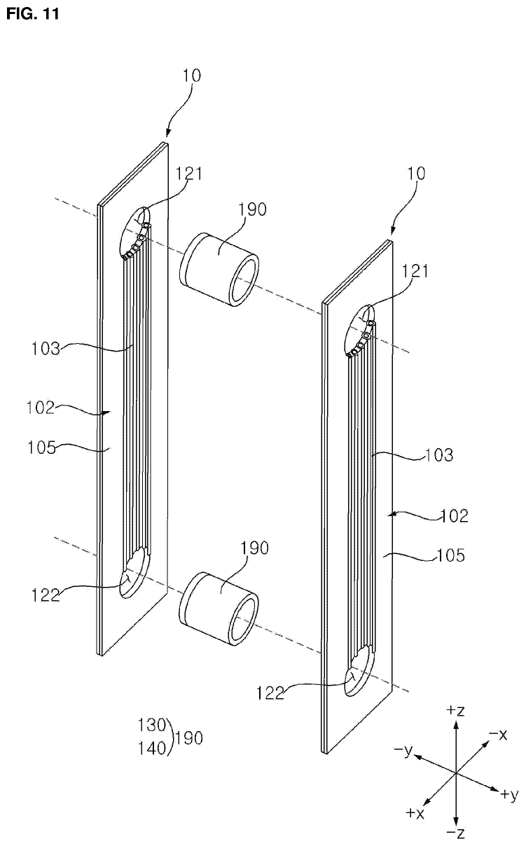

Referring to FIG. 11, like the embodiments described above, the heat exchanger according to this embodiment may include a fin tube 10 provided in plurality, and each of the plurality of fin tubes 10 may include a fin 102 for heat transfer and a plurality of tubes 103 through which refrigerant flows integrally formed on a plate having a first surface 105 and a second surface 106 opposite to each other, and openings 121 and 122 on one side and another side of the plurality of tubes 103 to communicate with the plurality of tubes 103.

In this embodiment, a connection part 190 of a tube shape may be disposed between openings 121, 122 of fin tubes 10 adjacent to each other. The connection part 190 may be manufactured as an independent part as the first connection part 130 and the second connection part 140 shown in FIGS. 2 to 5, or may be manufactured as an integrated type of the connection part 190 having the tube shape as shown in this embodiment.

The connection part 190 may connect openings 121, 122 of fin tubes 10 adjacent to each other to allow the openings 121, 122 to communicate with each other, so that refrigerant flows between the openings 121, 122 of the fin tubes 10 adjacent to each other.

Unlike the connection part 190 formed separately from the fin tube 10 to be joined to peripheries of openings 121, 122 adjacent to each other, the connection part 190 may be formed integrally with the fin tube 10 in a manner of protruding toward an opening 121, 122 of a fin tube 10 adjacent to a periphery of the opening 121, 122 of the fin tube 10.

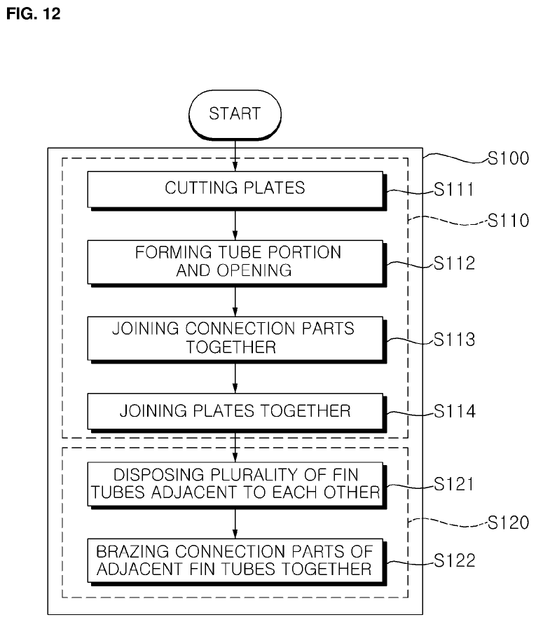

Referring to FIG. 12, a method of manufacturing a fin tube (S110) according to one embodiment of the present disclosure will be described.

The method may include cutting a first plate 11 and a second plate 12 into the size of a fin tube 10 (S111).

The method may include coupling the first plate 11 and the second plate 12 to each other to respectively form tube portions 113 and 123 defining a plurality of tubes 103 in a protruding manner, and forming an opening 120 on at least one side of the tube portions 113 and 123 to be spaced apart from an edge of each of the first plate 11 and the second plate 12 (S112).

The method may include forming a first connection part 130 on a periphery of an opening 120 of a first surface 105 that is an outer surface of the first plate 11 and forming a second connection part 130 on a periphery of an opening 120 of a second surface 10 that is an outer surface of the second plate 12, and joining the first connection part 130 to the first plate 11 and joining the second connection part 14 to the second plate 12 (S113).

The method may include joining an inner surface of the first plate 11 and an inner surface of the second plate 12 together (S114).

The order of forming the connection parts 130 and 140 on the respective plates 11 and 12 to join the connection parts to the respective plates 11 and 12 (S113) and joining of the plates 11 and 12 together (S114) may be interchanged.

A method of manufacturing a heat exchanger (S100) according to one embodiment of the present disclosure may include, after manufacturing the fin tube 10 according to the method (S110), coupling a first connection part 130 of the fin tube 10 and a second connection part 140 of an adjacent fin tube to each other (S120). A protrusion 133, 136 formed on the first connection part 130 may be inserted into a groove 142, 144 formed on the second connection part 140 of the adjacent fin tube 10.

The coupling of the first connection part 130 of the fin tube 10 and the second connection part 140 of the adjacent fin tube 10 to each other (S120) may include disposing a plurality of fin tubes 10 adjacent to each other (S121).

The coupling of the first connection part 130 of the fin tube 10 and the second connection part 140 of the adjacent fin tube 10 to each other (S120) may include adding a filter metal to at least one of the protrusion (133, 136) and the groove (142, 144) so as to braze the first connection part 130 and the second connection part 140 of the fin tubes 10 adjacent to each other (S122).

Although preferred embodiments of the present disclosure have been shown and described herein, the present disclosure is not limited to the specific embodiments described above. It will be understood that various modifications and changes can be made by those skilled in the art without departing from the idea and scope of the present disclosure as defined by the appended claims. Therefore, it shall be considered that such modifications, changes, and equivalents thereof are all included within the scope of the present disclosure.

1. A heat exchanger comprising:
a plurality of in tubes, each of the plurality of fin tubes comprising a fin and a plurality of tubes through which refrigerant flows, and the fin and a plurality of tubes for each of the plurality of fin tubes being integrally formed as a plate,
wherein one of the fin tubes includes:
a first surface and a second surface opposite to the first surface;
an opening in communication with at least one side of the plurality of tubes and formed through at least one of the first surface or the second surface; and
a connection conduit configured to connect peripheries of openings of an adjacent pair of the plurality of fin tubes, so that the openings of the adjacent pair of the fin tubes communicate with each other.

2. The heat exchanger of claim 1, wherein the connection conduit protrudes in a tube shape from the first surface of a first fin tube of the adjacent pair of fin tubes toward the second surface of a second fin tube of the adjacent pair of fin tubes.

3. The heat exchanger of claim 1, wherein the connection conduit is a tube that is joined to the periphery of each of the openings of the of the adjacent pair of fin tubes.

4. The heat exchanger of claim 1,
wherein the connection conduit comprises:
a first connection conduit formed on the periphery of the opening of the first surface of a first fin tube of the adjacent pair of fin tubes; and
a second connection conduit formed on the periphery of the opening of the second surface a second fin tube of the adjacent pair of fin tubes, and
wherein the first connection conduit and the second connection conduit are coupled together.

5. The heat exchanger of claim 4,
wherein the first connection conduit is configured to protrude from the first surface of the first fin tube toward the second surface of the second fin tube adjacent to the first fin tube, and
wherein the second connection conduit is configured to protrude from the second surface of the second fin tube toward the first surface of the first fin tube adjacent to the second fin tube.

6. The heat exchanger of claim 5, wherein a distance between the first surface of the first fin tube and the second surface of the adjacent second fin tube is greater than a sum of a thickness of a first tube region formed on the first surface of the first fin tube and a thickness of a second tube region formed on the second surface of the adjacent second fin tube such that a space is formed between the first and second tube regions of the adjacent pair of fin tubes.

7. The heat exchanger of claim 4, wherein the first connection conduit includes a protrusion, and
wherein the second connection conduit includes a groove into which the protrusion is inserted.

8. The heat exchanger of claim 7,
wherein the protrusion has a closed-loop shape, and
wherein the groove has a closed-loop shape.

9. (canceled)

10. The heat exchanger of claim 4, wherein the plurality of fin tubes are provided parallel to each other, with the first connection conduits and second connection conduits of respective adjacent pairs of the fin tubes being coupled to each other.

11. The heat exchanger of claim 10, wherein the plurality of fin tubes are configured such that the openings of the plurality of fin tubes communicate with each other to define a refrigerant passage that carries refrigerant via the plurality of tubes formed, respectively, on the plurality of fin tubes.

12. The heat exchanger of claim 4, wherein each of the plurality of fin tubes include the openings on each of the first surface mid the second surface.

13. The heat exchanger of claim 4, wherein each of the plurality of fin tubes has the opening on each of a first end and a second end of the plurality of tubes, and on the first surface and the second surface.

14. (canceled)

15. The heat exchanger of claim 1, wherein each of the plurality of fin tubes is includes a first plate and a second plate that are joined together,
wherein the first surface is an outer surface of the first plate, and
wherein the second surface is an outer surface of the second plate.

16. The heat exchanger of claim 15, wherein first regions of the first plate and the second plate are joined together to define the fin and the plurality of tubes and the opening are formed at second regions of the first plate and the second plate.

17. The heat exchanger of claim 16, wherein the opening is spaced a predetermined distance apart from edges of the first plate and the second plate and toward the plurality of tubes, and
wherein the fin comprises a fin region formed between the opening and the edges of the first plate and the second plate.

18. A method of manufacturing a heat exchanger including a fin tube, the method comprising:
cutting a first plate and a second plate into a size of the fin tube;
coupling the first plate and the second plate to each other to form respective tube regions defining a tube in a protruding manner and forming an opening on at least one side of each of the tube regions to be spaced apart from respective edges of the first plate and the second plate;
forming a first connection conduit on a periphery of the opening of the first plate and forming a second connection conduit on a periphery of the opening of the second plate; and
joining an inner surface of the first plate and an inner surface of the second plate together.

19. The method of h claim 18, further comprising:
coupling the first connection conduit of the fin tube and the second connection part of an adjacent fin tube.

20. The method of claim 19, wherein a distance between a first plate of the fin tube and a second plate of the adjacent fin tube is greater than a sum of a thickness of a first tube portion included in the first plate of the fin tube and a thickness of a second tube portion included in the second plate of the adjacent fin tube, so as to form a space between the fin tube and the adjacent fin tube.

21. The method of claim 19,
wherein forming the first and second connection conduits includes forming a protrusion on the first connection conduit, and forming a groove in the second connection conduit of the adjacent fin tube, and
wherein coupling the first connection conduit of the fin tube and the second connection part of the adjacent fin tube includes inserting the protrusion of the first connection conduit into the groove of the second connection conduit.

22. The method of claim 21, further comprising:
adding a filler metal to at least one of the protrusion or the groove; and melting the filler metal to seal between the first connection part conduit and the second connection conduit.

23. (canceled)
